(19) United States
(12) Patent Application Publication
(10) Pub. No.: US 2026/0170440 A1
(43) Pub. Date: Jun. 18, 2026

(54) MODIFICATION OF UPLIFT MODEL BEHAVIOR FOR GENERATING ROOT CAUSE VISUALIZATIONS VIA INPUT DATA PREPROCESSING

(71) Applicant: American Express Travel Related Services Company, Inc., New York, NY (US)

(72) Inventors: Leonie Tabea Goldmann, Brooklyn, NY (US); Anton Hinel, London (GB); Artur Sokolovsky, Haywards Heath (GB); Philipp Bartel, London (GB); Hao Li, London (GB)

(73) Assignee: American Express Travel Related Services Company, Inc., New York, NY (US)

(21) Appl. No.: 18/986,001

(22) Filed: Dec. 18, 2024

(51) Int. Cl. G06Q 10/0637

(52) U.S. Cl. CPC G06Q 10/06375

(57) ABSTRACT

A computing device may receive a data file and an indication of a target data type. The data file and the indication of the target data type may be received based on an interaction with a user interface. The data file may be segmented into a plurality of segments based on a rule associated with the target data type. Each segment of the plurality of segments may be assigned a respective weighted value that represents a degree of influence on the target data type. A respective causal score for each segment of the plurality of segments may be determined. The causal score may represent a contribution of a segment to a change in the target data type. A user interface may display an indication of the respective causal score for each segment of the plurality of segments.

### BACKGROUND

Understanding the factors that drive changes in performance metrics is crucial for strategic planning and decision-making, particularly in fields such as finance, advertising, identity management, and/or the like. Key portfolio metrics change over time, and in order to find out which segments caused this change, univariate analyses for each segment in terms of mix and performance need to be done. These manual analyses are not only time-consuming but also fall short of distinguishing between correlation and causation, making it challenging to identify which segments of data/information are actually influencing performance changes. Due to an inability to focus on the incremental impact of different data segments, entities are unable to use traditional analytics techniques to isolate and understand the true drivers of performance improvements.

### SUMMARY

Provided herein are system, apparatus, device, method and/or computer program product embodiments, and/or combinations and sub-combinations thereof, for modification of uplift model behavior for generating root cause visualizations via data preprocessing. The technical improvement described herein is to the functionality of a particular uplift model within a multivariate system by adjusting the inputs to an uplift model to achieve novel visualizations that were not previously accessible in conventional systems that deployed uplift models; the use of a tool for adjusting inputs to an uplift model allows for the display of interfaces depicting the identified causal relationships within the context of the multivariate system.

In some embodiments, a computing device may receive a data file and an indication of a target data type. The data file and the indication of the target data type may be received based on an interaction with a user interface. The data file may be segmented into a plurality of segments based on a rule associated with the target data type. Each segment of the plurality of segments may be assigned a respective weighted value that represents a degree of influence on the target data type. A respective causal score for each segment of the plurality of segments may be determined. The causal score may represent a contribution of a segment to a change in the target data type. A user interface may display an indication of the respective causal score for each segment of the plurality of segments.

### BRIEF DESCRIPTION OF THE DRAWINGS

The accompanying drawings are incorporated herein and form a part of the specification.

FIG. 1 is a block diagram of an example system for a modified uplift model for generating root cause visualizations, according to some aspects of this disclosure.

FIG. 2 is a flowchart of an example method for modifying uplift model behavior for generating root cause visualizations via data preprocessing, according to some aspects of this disclosure.

FIG. 3 is a flowchart of an example method for modifying uplift model behavior for generating root cause visualizations via data preprocessing, according to some aspects of this disclosure.

FIG. 4 is an example computer system useful for implementing various embodiments. In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for modification of uplift model behavior for generating root cause visualizations via data preprocessing. Uplift modelling (e.g., incremental response modelling, net lift modelling, causal inference modelling, treatment modelling, etc.) is a predictive modeling technique for estimating the incremental impact of an action or treatment on an outcome, such as actions or factors that affect a user's behavior and/or the like. As described herein, an uplift model may be used for analysis of different data models and contexts, such as financial models. As described herein, time-series data may be modified and prepared for input into an uplift model to enable an accurate estimation of the incremental effects of a treatment on a particular outcome.

Conventional artificial intelligence (AI) and machine learning models are used to algorithmically analyze data and provide predictions related to a target output. However, conventional models do not effectively process data to assess relationships between multivariate factors to identify causation for given outputs. For instance, relating to financial data, due to the data being collected from disparate data sources and being heterogeneous in content, format, and type, conventional artificial intelligence (AI) and machine learning models are not efficient, may require high processing power, and may not yield accurate results. Routinely, uplift models cannot be applied to certain data contexts, such as financial models, due to the time-series nature of financial data and the real-time (or near real-time) decision making requirements that are involved in financial technical contexts, without effective preprocessing of data an uplift model may fail to output accurate results. As described herein, time-series data may be preprocessed and transformed into a format suitable for use in uplift modeling, thereby improving the ability of an uplift model to estimate the true incremental effect of an intervention. For example, time-series data may be segmented into multiple time windows, temporal features may be created from each window, and the time-series data may be aligned with corresponding treatment and control group labels. As described herein, time-series data transformation preserves the time-dependent characteristics of the data and allows uplift models to accurately predict the impact of an intervention over time. The uplift model described herein is capable of receiving and processing data input at larger volume, capacity, and complexity, and perform rapid data processing and modeling to provide real-time, or near real-time, graphical user interfaces depicting root cause visualizations for decision making.

As described herein, a status of a digital identity may be affected by multiple variables (e.g., financial activity, spending patterns, credit utilization, online behavior, etc.) associated with a user model. According to some aspects of this disclosure, user models may be logical, mathematical, and/or data constructs that represent relationships between different variables or features that influence the status of a digital identity. For example, a user model may capture complex payment instrument usage, financial data, behavioral patterns, and/or the like using mathematical functions, algorithms, and/or computational models. For example, according to some aspects of this disclosure, user models may include linear models, non-linear models, stochastic models, time-series models, state-space models, agent-based models, and/or the like. User models may include both mutable and immutable features. According to some aspects of this disclosure, multivariate analysis of a user model (or a plurality of user models) may be performed to identify segments of user model data that affect a target metric over a given time period, and may be used to identify the incremental impact of a treatment (e.g., offering a loan or a credit limit increase, etc.) on the probability of an outcome (e.g., loan default, loan repayment, etc.).

For example, as described herein, an entity may provide a specially trained predictive model (e.g., an uplift model, a causation model, a treatment model, a persuasion model, etc.) select data/information (e.g., a curated dataset, raw data, etc.) based on an interaction (e.g., via drag and drop, etc.) with a user interface. The user interface may enable any time periods of interest (e.g, control and peak period, etc.) and/or metric of interest to be selected by a user and provided to the predictive model. The predictive model may isolate and understand any drivers of a target metric (e.g., a metric of interest, etc.). These and other advantages are described herein.

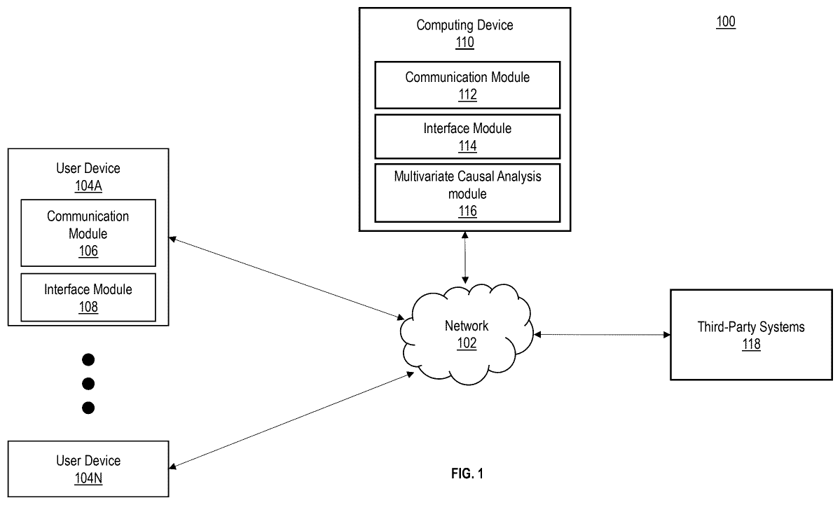

FIG. 1 shows a block diagram of an example system 100 for modified uplift model for generating root cause visualizations. System 100 is merely an example of one suitable system environment and is not intended to suggest any limitation as to the scope of use or functionality of aspects described herein. Neither should the system 100 be interpreted as having any dependency or requirement related to any single device/module/component or combination of devices/modules/components described therein.

According to some aspects of this disclosure, system 100 may include a network 102. According to some aspects of this disclosure, network 102 may include a packet-switched network (e.g., internet protocol-based network), a non-packet switched network (e.g., quadrature amplitude modulation-based network), and/or the like. According to some aspects of this disclosure, network 102 may include network adapters, switches, routers, modems, and the like connected through wireless links (e.g., radiofrequency, satellite) and/or physical links (e.g., fiber optic cable, coaxial cable, Ethernet cable, or a combination thereof). Network 102 may include public networks, private networks, wide area networks (e.g., Internet), local area networks, and/or the like. According to some aspects of this disclosure, network 102 may include a content access network, content distribution network, and/or the like. According to some aspects of this disclosure, network 102 may provide and/or support communication from telephone, cellular, modem, and/or other electronic devices to and throughout the system 100. For example, system 100 may include and support communications between user devices 104A-104N, computing device 110, and third-party systems 118 via network 102.

According to some aspects of this disclosure, user devices 104A-104N may be part of a client and/or user computing system and/or infrastructure. For example, user devices 104A-104N may represent a plurality of user devices in communication and/or interoperability within a client and/or user computing system and/or infrastructure. Although user device 104A is described herein in greater detail, each user device 104A-104N may be similarly configured.

According to some aspects of this disclosure, user device 104A may include, for example, a smart device, a mobile device, a laptop, a tablet, a display device, a computing device, or any other device capable of communicating with computing device 110, third-party systems 118, and/or any other device/component of system 100, either described or unshown. User device 104A may include communication module 106 that facilitates and/or enables communication with network 102 (e.g., devices, components, and/or systems of network 102, etc.), computing device 110, and/or any other device/component of system 100. For example, communication module 106 may include hardware and/or software to facilitate communication. According to some aspects of this disclosure, communication module 106 may include one or more of a modem, transceiver (e.g., wireless transceiver, etc.), digital-to-analog converter, analog-to-digital converter, encoder, decoder, modulator, demodulator, tuner (e.g., QAM tuner, QPSK tuner), and/or the like. According to some aspects of this disclosure, communication module 106 may include any hardware and/or software necessary to facilitate communication.

According to some aspects of this disclosure, User device 104A may include an interface module 108. According to some aspects of this disclosure, interface module 108 enables a user to interact with user device 104, network 102, computing device 110, and/or any other device/component of system 100. Interface module 108 may include any interface for presenting and/or receiving information to/from a user.

According to some aspects of this disclosure, interface module 108 enables a user to view and/or interact with content, applications, web pages, and/or user interfaces. According to some aspects, interface module 108 may include a web browser (e.g., Internet Explorer®, Mozilla Firefox®, Google Chrome®, Safari®, or the like). According to some aspects, interface module 108 may include one or more applications including credit management applications, financial applications, e-commerce applications, identity management applications, and/or the like. According to some aspects, interface module 108 may request or query various files from a local source and/or a remote source, such as computing device 110, third-party systems 118, and/or any other device/component of system 100. For example, interface module 108 may facilitate one or more transactions including credit approval transactions, product purchase transactions, communication-based transactions, and/or the like.

According to some aspects, interface module 108 may include one or more input devices and/or components, for example, such as a keyboard, a pointing device (e.g., a computer mouse, remote control), a microphone, a joystick, a tactile input device (e.g., touch screen, gloves, etc.), and/or the like. According to some aspects, interaction with the input devices and/or components may enable a user to interact with a user interface generated and/or displayed by the interface module 108 and/or the like. According to some aspects of this disclosure, interaction with the input devices and/or components may enable a user to manipulate and/or interact with components of a user interface, for example, such as interactive elements, transaction facilitation tools, and/or the like.

According to some aspects of this disclosure, user devices 104A-104N may generate and/or output data/information that may be used to build user profiles for users of the user devices 104A-104N. For example, data indicative of the frequency and types of online purchases may be tracked to indicate user spending habits, location data from user devices 104A-104N may indicate and/or be used to infer behavior patterns, data indicative of how users interact on web-based, online, and social media platforms may indicate and/or be used to infer behavior patterns, and/or the like.

According to some aspects of this disclosure, data/information that may be used to build user profiles for users of the user devices 104A-104N may be collected and/or provided via third-party systems 118. Third-party systems 118 may include a system, compute infrastructure/architecture, and/or software platform configured to access a plurality of software applications, services, and/or data sources. Third-party systems 118 may include, facilitate, and/or support social networks, payment networks, blockchain, e-commerce, financial transactions, payment acceptance/remittance services, content acquisition and delivery services, identity management and security systems, and/or the like.

Third-party systems 118 may include, access, support, and/or host any applications and/or data through any delivery paradigm, including but not limited to remote or distributed cloud computing solutions, local or on-premises software (“on-premise” cloud-based solutions), cloud-based services, “as a service” models (e.g., content as a service (CaaS), digital content as a service (DCaaS), software as a service (SaaS), managed software as a service (MSaaS), platform as a service (PaaS), backend as a service (BaaS), mobile backend as a service (MBaaS), infrastructure as a service (IaaS), etc.), and/or the like. Third-party systems 118 may include and/or support systems including, but not limited to, commercial entities (e.g., merchant devices, e-commerce platforms, etc.), financial institutions and/or finance-supporting institutions (e.g., banks, credit card companies, government agencies, etc.), and/or the like that interact with user devices 104A-104N. Data and/or information communicated between user devices 104A-104N and third-party systems 118 may be collected and used to generate user models for user devices 104A-104N and/or users of user devices 104A-104N.

According to some aspects of this disclosure, computing device 110 may include a server, a cloud-based compute resource, an entity-controlled device, or any other device capable of communicating with user devices 104A-104N, third-party systems 118, and/or any other device/component of system 100, either described or (un) shown. Although shown as a single device, according to some aspects of this disclosure, computing device 110 may be part of a computing system and/or infrastructure, and/or may represent a plurality of computing devices. For example, computing device 110 may represent a plurality of computing devices in communication with user devices 104A-104N, third-party systems 118, and/or any other device/component of system 100.

According to some aspects of this disclosure, computing device 110 may include communication module 112 that facilitates and/or enables communication with network 102 (e.g., devices, components, and/or systems of network 102, etc.), user devices 104A-104N, third-party systems 118, and/or any other device/component of system 100. For example, communication module 112 may include hardware and/or software to facilitate communication. According to some aspects of this disclosure, communication module 112 may include one or more of a modem, transceiver (e.g., wireless transceiver, etc.), digital-to-analog converter, analog-to-digital converter, encoder, decoder, modulator, demodulator, tuner (e.g., QAM tuner, QPSK tuner), and/or the like. According to some aspects of this disclosure, communication module 112 may include any hardware and/or software necessary to facilitate communication.

According to some aspects of this disclosure, computing device 110 may include an interface module 114. According to some aspects of this disclosure, interface module 114 enables a user to interact with computing device 110, network 102, user device 104A-104N, third-party systems 118, and/or any other device/component of system 100. Interface module 114 may include any interface for presenting and/or receiving information to/from a user.

According to some aspects of this disclosure, interface module 114 enables a user to view and/or interact with user data, applications, web pages, and/or user interfaces. According to some aspects, interface module 114 may include a web browser (e.g., Internet Explorer®, Mozilla Firefox®, Google Chrome®, Safari®, or the like). According to some aspects, interface module 114 may include one or more applications including credit management applications, financial applications, e-commerce applications, identity management applications, and/or the like. According to some aspects, interface module 114 may request, receive, or query various files from a local source and/or a remote source, such as user devices 104A-104N, third-party systems 118, and/or any other device/component of system 100.

According to some aspects, interface module 114 may include one or more input devices and/or components, for example, such as a keyboard, a pointing device (e.g., a computer mouse, remote control), a microphone, a joystick, a tactile input device (e.g., touch screen, gloves, etc.), and/or the like. According to some aspects, interaction with the input devices and/or components may enable a user to upload data (e.g., financial data, credit risk data, digital identity-related data, etc.) indicative of user models to be analyzed by a multivariate causal analysis model (e.g., an uplift model, a causation model, a treatment model, a persuasion model, etc.) to provide insight for different scenarios and/or performance indicators related to the data. For example, computing device 110 may be in communication with an entity's internal data repository, and data can be uploaded via drag-and-drop actions and/or the like. After uploading the dataset, time periods of interest and metrics of interest may be indicated and/or selected by a user. Multivariate causal analysis of the data may then be performed and the results may be displayed via a user interface of the interface module 114.

To generate root cause visualizations for target data, computing device 110 may include a multivariate causal analysis module 116. Multivariate causal analysis module 116 may include a uplift model for generating root cause visualizations for target data. Multivariate causal analysis module 116 analyzes data from user models (e.g., functional representations of financial activity, user behavior, user credit-related activity, account balances, transaction history, etc.) for users of user devices 104A-104N and/or user devices 104A-104N. In a situation where data provided to multivariate causal analysis module 116 contains financial data, multivariate causal analysis module 116 may include a specially trained predictive model that identifies factors that drive changes in a target performance metrics. Traditional analytic systems are time-intensive and operate in a univariate and hypothesis driven way. Hence, traditional analytic systems routinely struggle to identify which segments of the financial data are actually influencing performance changes. c may identify the incremental impact of different data segments, and supports real-time data processing so that multivariate causal analysis module 116 may be integrated with financial data sources including, but not limited to, online financial systems. For example, time-series data may be prepared for input into multivariate causal analysis module 116 to enable the accurate estimation of the incremental effects of a treatment on a particular outcome. A time-series dataset may be received from any source including, but not limited to, a database, a live feed, and/or the like. The time-series dataset may include a series of data points, each associated with a specific timestamp, representing an evolving value over time (e.g., sales, website traffic, sensor readings, etc.). The time-series data may be divided into discrete time windows. According to some aspects of this disclosure, each time window may contain a subset of data points that corresponds to a defined period, such as a day, week, or month. The size of the time window may be selected based on the granularity of the time-series data and the nature of the intervention being studied. For each time window, a set of temporal features may be generated. These features may include, but are not limited to, user/customer attributes at the given time-period (e.g., a user/customer's FICO score for a month, etc.), statistical summaries (e.g., mean, median, variance, a standard deviation of values within the window, etc.), trend indicators (e.g., data derived by fitting a linear or polynomial regression model to detect upward or downward trends, etc.), seasonality features, lag features (e.g., previous time window values used as predictive features in a current time window, etc.).

With temporal features generated, the time-series data may be aligned with treatment and control group labels. A treatment group may consist of instances where a target data occurrence (e.g., an intervention) is applied, and a control group may be instances where no intervention occurred. Alignment of the time-series data may ensure that multivariate causal analysis module 116 can identify the differential effect between the two groups while accounting for temporal dependencies. Normalization or scaling may be applied to the time-series data to ensure comparability between the treatment and control groups.

A structured dataset may be generated where each row represents a time window with the associated temporal features and the treatment/control label. The structured dataset may be input into multivariate causal analysis module 116. Multivariate causal analysis module 116 may estimate, forecast, and/or predict the incremental effect of the intervention on the outcome. Multivariate causal analysis module 116 may leverage temporal features to account for time-based relationships and accurately predict the true impact of a treatment over time. According to some aspects of this disclosure, a treatment used for analysis may include another time-period of interest (e.g., time may be used as a treatment dimension, etc.).

In an example scenario, multivariate causal analysis module 116 may receive, request, and/or access user information (e.g., financial data and performance metrics over multiple time periods, etc.) from user devices 104A-104N and/or third-party services 118 to analyze user models. Multivariate causal analysis module 116 may be configured to remove inconsistencies and outliers from the financial data to ensure accuracy. Multivariate causal analysis module 116 may segment financial data into various categories based on predefined criteria. Segementation of the financial data may be based on criteria including, but not limited to, product lines, customer demographics, geographical regions, time periods, and/or the like. A user interface may interacted with to enable dynamic manipulation of segmentation criteria. Segmented financial data may include, but is not limited to, historical transactions, account balances, credit scores, demographic information, information indicative of interactions with financial products or services, and treatment information (e.g., users exposed to a treatment, users not exposed to a treatment, etc.).

Segmented data may be normalized to facilitate effective modeling and comparison. Normalization may include addressing missing values via imputation or removal, standardizing numerical features, and/or the like. Multivariate causal analysis module 116 may be specially trained on curated features to provide insights for financial data including the incremental effect of a treatment (e.g., a marketing campaign) on an outcome (e.g., loan repayment, investment behavior, etc.) compared to a control group. Training multivariate causal analysis module 116 may include splitting financial data into training, validation, and test sets

A user may identify features of financial data that may include, but are not limited to, averages/trends in account balances, user debt-to-income ratios, identified expenditures, and/or the like. Rather than defining treatment and control groups associated with received data, as described herein, uplift models may be used to compare events according to time-periods of occurrence. According to some aspects of this disclosure, the multivariate causal analysis module 116 may use techniques including, but not limited to, predicted probabilities, Difference-in-Differences (DiD), uplift random forests, causal forests, and/or the like. According to some aspects of this disclosure, multivariate causal analysis module 116 may include a model trained on a random dataset and used to interpret shapley values of a test dataset.

According to some aspects of this disclosure, multivariate causal analysis module 116 may be a regression model that predicts a target variable with a time-period flag added to the feature space. To manage time-series data, a time-period flag may be added to the feature space, multivariate causal analysis module 116 may change the input value, and the predicted change in the input value may be observed. For example, a predicted conditional treatment effect for an individual unit may be the difference between the predicted values the time-period flag is changed from control to peak, with all other features held fixed. A qini may be calculated as for multivariate causal analysis module 116, but instead of using the cumulative amount of positive outcomes, the cumulative sum of the multivariate causal analysis module 116 may be used. Multivariate causal analysis module 116 may be trained on a random dataset and shapely additive explanation values of test data may be interpreted. A large treatment effect may be interpreted as a large change in the original model prediction of a continuous target. Shapely additive performance values may highlight the features responsible for the large treatment effect.

Multivariate causal analysis module 116 may use one or more methods including, but not limited to, decision tree analysis, random forest analysis, gradient boosting, and/or the like on a training dataset to interpret feature importance. Immutable features may be identified by identifying those features that show consistent importance across multiple runs and different subsets of the training dataset. Mutable features may be identified by identifying those features that show fluctuating levels of importance over time or across different subsets of the training dataset.

Outputs of multivariate causal analysis module 116 may be validated via A/B testing, randomized controlled trials, and/or the like to ensure outputs align with real-world results. Insights derived from outputs of the multivariate causal analysis module 116 may provide actionable recommendations, such as targeting specific customer segments with personalized financial offers, designing new financial products tailored to high-response groups, and adjusting marketing strategies.

Multivariate causal analysis module 116 may be continuously improved by incorporating new data, refining features, and dynamic user modeling to ensure adaptation to new data including, but not limited to, new data indicative of changing financial behaviors and market conditions.

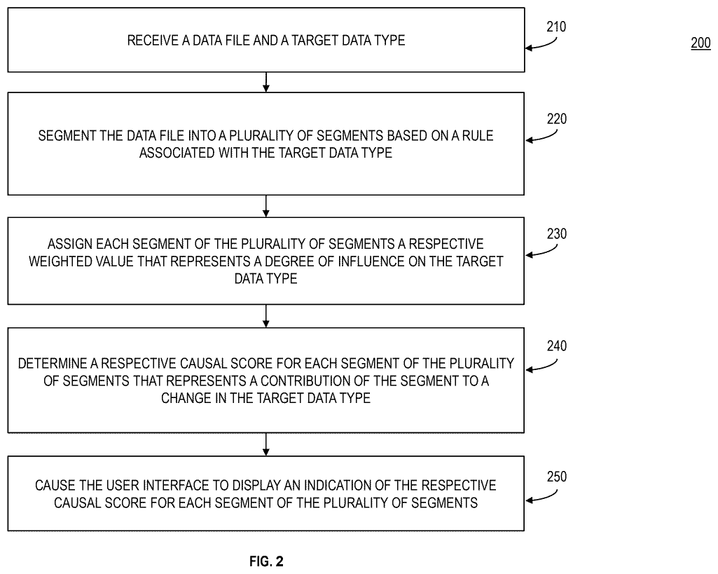

FIG. 2 is a flowchart for a method 200 for multivariate causal analysis, according to aspects of this disclosure. Method 200 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 2, as will be understood by a person of ordinary skill in the art.

Method 200 shall be described with reference to FIG. 1. However, method 200 is not limited to those figures or related aspects.

In 210, computing device 110 receives a data file and an indication of a target data type. According to some aspects of this disclosure, computing device 110 may receive the data file and an indication of a target data type based on an interaction with a user interface. For example, a user interface may provide an interactive element for uploading the data file and providing an indication of the target data type. According to some aspects of this disclosure, the data file may indicate data collected from a plurality of user devices that each executed at least one transaction via a respective digital instrument. According to some aspects of this disclosure, the target data type may include, but is not limited to, financial data, user behavioral data, and/or the like.

In 220, computing device 110 segments the data file into a plurality of segments based on a rule associated with the target data type. According to some aspects of this disclosure, the rule associated with the target data type may define control segments and treatment segments for the plurality of segments.

In 230, computing device 110 assigns each segment of the plurality of segments a respective weighted value that represents a degree of influence on the target data type. According to some aspects of this disclosure, the respective weighted value for each segment of the plurality of segments may determined based at least in part on whether the segment is defined as a control segment or a treatment segment.

In 240, computing device 110 determines a respective causal score for each segment of the plurality of segments that represents a contribution of the segment to a change in the target data type. and

In 250, computing device 110 causes the user interface to display an indication of the respective causal score for each segment of the plurality of segments. According to some aspects of this disclosure, the indication of the respective causal score for each segment of the plurality of segments may be displayed as a waterfall plot and/or the like. For example, the waterfall plot may be used to effectively visualize how different segments contribute to a total uplift in a target data element (e.g., credit risk, default accounts, etc.).

According to some aspects of this disclosure, method 200 may further include computing device 110 determining a root cause of an occurrence indicated by the data file. For example, computing device 110 may determine the root cause of an occurrence indicated by the data file based on a data pattern indicated by segments of the plurality of segments with respective causal scores that satisfy a threshold.

According to some aspects of this disclosure, method 200 may further include computing device 110 sending an instruction to a user device associated with a segment of the plurality of segments with a respective causal score that satisfies a threshold. For example, the instruction may instruct the user device or a user of the user device to modify user behavior associated with a digital instrument, a financial behavior associated with the digital instrument, and/or the like.

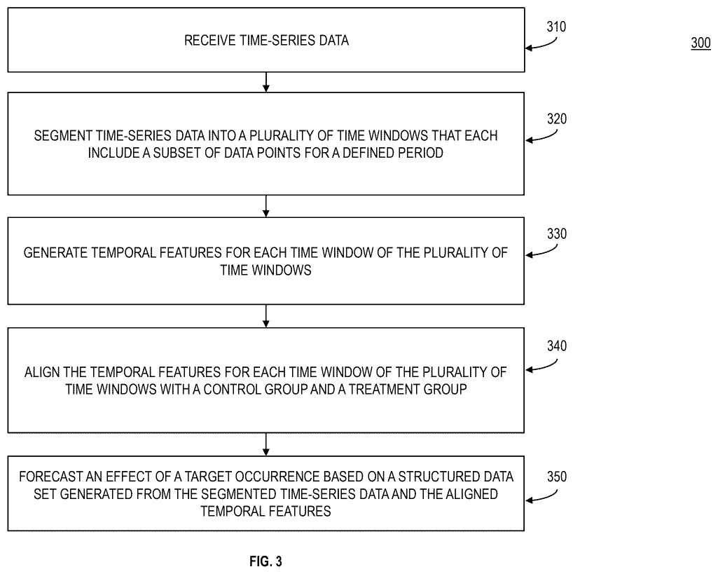

FIG. 3 is a flowchart for a method 300 for multivariate causal analysis, according to aspects of this disclosure. Method 300 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 3, as will be understood by a person of ordinary skill in the art.

Method 300 shall be described with reference to FIG. 1. However, method 300 is not limited to those figures or related aspects.

In 310, computing device 110 receives a time-series dataset comprising a plurality of sequential data points. According to some aspects of this disclosure, each data point may represent a value at a specific time.

In 320, computing device 110 segments the time-series dataset into a plurality of time windows. Each time window of the plurality of time windows may include a subset of data points representing a defined period.

In 330, computing device 110 generates temporal features for each time window of the plurality of time windows. According to some aspects of this disclosure, the temporal features may include statistical summaries, including but not limited to, moving averages, trends, seasonality indicators, lagged values derived from previous time windows, and/or the like.

In 340, computing device 110 aligns the temporal features with corresponding treatment and control group labels. According to some aspects of this disclosure, the treatment group may correspond to instances subjected to a specified intervention or target occurrence. The control group may correspond to instances not subjected to the intervention or target occurrence.

In 350, computing device 110 forecasts a differential effect/impact of the intervention or target occurrence on a target outcome between the treatment group and the control group based on the structured data set indicative of the transformed and aligned time-series data. computing device 110 may forecast an incremental effect of the intervention or target occurrence by identifying temporal dependencies in the time-series data.

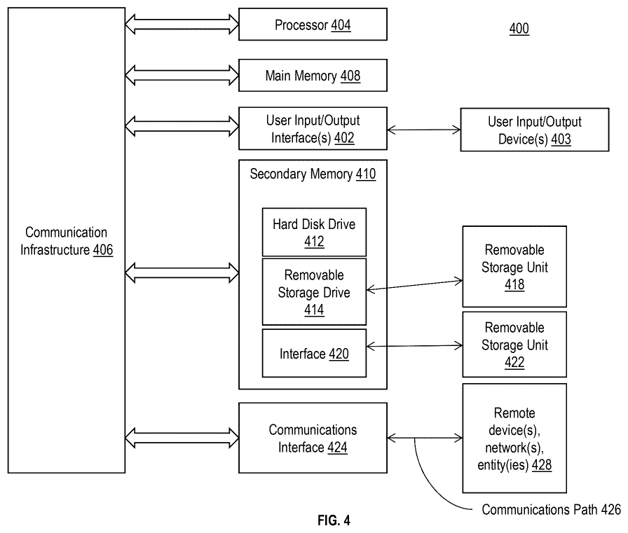

Various embodiments may be implemented, for example, using one or more well-known computer systems, such as computer system 400 shown in FIG. 4. One or more computer systems 400 may be used, for example, to implement any of the embodiments discussed herein, as well as combinations and sub-combinations thereof.

Computer system 400 may include one or more processors (also called central processing units, or CPUs), such as a processor 404. Processor 404 may be connected to a communication infrastructure or bus 406.

Computer system 400 may also include user input/output device(s) 403, such as monitors, keyboards, pointing devices, etc., which may communicate with communication infrastructure 406 through user input/output interface(s) 402.

One or more of processors 404 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 400 may also include a main or primary memory 408, such as random access memory (RAM). Main memory 408 may include one or more levels of cache. Main memory 408 may have stored therein control logic (i.e., computer software) and/or data.

Computer system 400 may also include one or more secondary storage devices or memory 410. Secondary memory 410 may include, for example, a hard disk drive 412 and/or a removable storage device or drive 414. Removable storage drive 414 may be a floppy disk drive, a magnetic tape drive, a compact disk drive, an optical storage device, tape backup device, and/or any other storage device/drive.

Removable storage drive 414 may interact with a removable storage unit 418. Removable storage unit 418 may include a computer usable or readable storage device having stored thereon computer software (control logic) and/or data. Removable storage unit 418 may be a floppy disk, magnetic tape, compact disk, DVD, optical storage disk, and/any other computer data storage device. Removable storage drive 414 may read from and/or write to removable storage unit 418.

Secondary memory 410 may include other means, devices, components, instrumentalities or other approaches for allowing computer programs and/or other instructions and/or data to be accessed by computer system 400. Such means, devices, components, instrumentalities or other approaches may include, for example, a removable storage unit 422 and an interface 420. Examples of the removable storage unit 422 and the interface 420 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 400 may further include a communication or network interface 424. Communication interface 424 may enable computer system 400 to communicate and interact with any combination of external devices, external networks, external entities, etc. (individually and collectively referenced by reference number 428). For example, communication interface 424 may allow computer system 400 to communicate with external or remote devices 428 over communications path 426, which may be wired and/or wireless (or a combination thereof), and which may include any combination of LANs, WANs, the Internet, etc. Control logic and/or data may be transmitted to and from computer system 400 via communication path 426.

Computer system 400 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 400 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 400 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 400, main memory 408, secondary memory 410, and removable storage units 418 and 422, as well as tangible articles of manufacture embodying any combination of the foregoing. Such control logic, when executed by one or more data processing devices (such as computer system 400), may cause such data processing devices to operate as described herein.

Based on the teachings contained in this disclosure, it will be apparent to persons skilled in the relevant art(s) how to make and use embodiments of this disclosure using data processing devices, computer systems, and/or computer architectures other than that shown in FIG. 4. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expressions “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still cooperate or interact with each other.

The breadth and scope of this disclosure should not be limited by any of the above-described exemplary embodiments, but should be defined only in accordance with the following claims and their equivalents.

What is claimed is:

1. A method comprising:
receiving, based on an interaction with a user interface, a data file and a target data type;
segmenting the data file into a plurality of segments based on a rule associated with the target data type;
assigning each segment of the plurality of segments a respective weighted value that represents a degree of influence on the target data type;
determining a respective causal score for each segment of the plurality of segments that represents a contribution of the segment to a change in the target data type; and
causing the user interface to display an indication of the respective causal score for each segment of the plurality of segments.

2. The method of claim 1, wherein the data file indicates data collected from a plurality of user devices that each executed at least one transaction via a respective digital instrument.

3. The method of claim 1, wherein the respective weighted values assigned to each segment of the plurality of segments are determined from at least one of: a predictive model trained to identify weights for segmented data based on data types, or based on a selection of the respective weighted values received via the user interface.

4. The method of claim 1, wherein the target data type comprises at least one of financial data or user behavioral data.

5. The method of claim 1, wherein the rule associated with the target data type defines control segments and treatment segments for the plurality of segments, and wherein the respective weighted value for each segment of the plurality of segments is determined based at least in part on whether the segment is defined as a control segment or a treatment segment.

6. The method of claim 1, further comprising determining, based on a data pattern indicated by segments of the plurality of segments with respective causal scores that satisfy a threshold, a root cause of an occurrence indicated by the data file.

7. The method of claim 1, further comprising sending an instruction to a user device associated with a segment of the plurality of segments with a respective causal score that satisfies a threshold, wherein the instruction instructs the user device to modify at least one of user behavior associated with a digital instrument or a financial behavior associated with the digital instrument.

8. A system, comprising:
a memory; and
at least one processor coupled to the memory and configured to perform operations comprising:
receiving, based on an interaction with a user interface, a data file and an indication of a target data type;
segmenting the data file into a plurality of segments based on a rule associated with the target data type;
assigning each segment of the plurality of segments a respective weighted value that represents a degree of influence on the target data type;
determining a respective causal score for each segment of the plurality of segments that represents a contribution of the segment to a change in the target data type; and
causing the user interface to display an indication of the respective causal score for each segment of the plurality of segments.

9. The system of claim 8, wherein the data file indicates data collected from a plurality of user devices that each executed at least one transaction via a respective digital instrument.

10. The system of claim 8, wherein the respective weighted values assigned to each segment of the plurality of segments are determined from at least one of: a predictive model trained to identify weights for segmented data based on data types, or based on a selection of the respective weighted values received via the user interface.

11. The system of claim 8, wherein the target data type comprises at least one of financial data or user behavioral data.

12. The system of claim 8, wherein the rule associated with the target data type defines control segments and treatment segments for the plurality of segments, and wherein the respective weighted value for each segment of the plurality of segments is determined based at least in part on whether the segment is defined as a control segment or a treatment segment.

13. The system of claim 8, the operations further comprising determining, based on a data pattern indicated by segments of the plurality of segments with respective causal scores that satisfy a threshold, a root cause of an occurrence indicated by the data file.

14. The system of claim 8, the operations further comprising sending an instruction to a user device associated with a segment of the plurality of segments with a respective causal score that satisfies a threshold, wherein the instruction instructs the user device to modify at least one of user behavior associated with a digital instrument or a financial behavior associated with the digital instrument.

15. A non-transitory computer-readable medium having instructions stored thereon that, when executed by at least one computing device, causes the at least one computing device to perform operations for a modified uplift model to generate root cause visualizations, the operations comprising:
receiving, based on an interaction with a user interface, a data file and an indication of a target data type;
segmenting the data file into a plurality of segments based on a rule associated with the target data type;
assigning each segment of the plurality of segments a respective weighted value that represents a degree of influence on the target data type;
determining a respective causal score for each segment of the plurality of segments that represents a contribution of the segment to a change in the target data type; and
causing the user interface to display an indication of the respective causal score for each segment of the plurality of segments.

16. The non-transitory computer-readable medium of claim 15, wherein the data file indicates data collected from a plurality of user devices that each executed at least one transaction via a respective digital instrument.

17. The non-transitory computer-readable medium of claim 15, wherein the respective weighted values assigned to each segment of the plurality of segments are determined from at least one of: a predictive model trained to identify weights for segmented data based on data types, or based on a selection of the respective weighted values received via the user interface.

18. The non-transitory computer-readable medium of claim 15, wherein the target data type comprises at least one of financial data or user behavioral data.

19. The non-transitory computer-readable medium of claim 15, wherein the rule associated with the target data type defines control segments and treatment segments for the plurality of segments, and wherein the respective weighted value for each segment of the plurality of segments is determined based at least in part on whether the segment is defined as a control segment or a treatment segment.

20. The non-transitory computer-readable medium of claim 15, the operations further comprising determining, based on a data pattern indicated by segments of the plurality of segments with respective causal scores that satisfy a threshold, a root cause of an occurrence indicated by the data file.
